(19) United States
(12) Patent Application Publication
(10) Pub. No.: US 2025/0289277 A1
(43) Pub. Date: Sep. 18, 2025

(54) TOW HOOK AND A METHOD OF PROVIDING AN ABOVE-BUMPER TOW HOOK ASSEMBLY

(71) Applicant: Larry Verbowski, Bay City, MI (US)

(72) Inventor: Larry Verbowski, Bay City, MI (US)

(21) Appl. No.: 18/608,188

(22) Filed: Mar. 18, 2024

(51) Int. Cl. B60D 1/52; B60D 1/48

(52) U.S. Cl. CPC B60D 1/52; B60D 1/488

(57) ABSTRACT

A method of providing an above bumper tow hook to a front of a pickup truck. Most such tow hooks are chassis mounted. However, they are all mounted underneath the bumper. The disadvantage is that when mired in snow or mud, one cannot access the tow hooks to attach any sort of tow cable to enable the vehicle to be towed. The method introduced herein deals with this issue by mounting the tow hook above the bumper. This entails manipulating the front fascia which sets down directly on the bumper. Also disclosed is a tow hook used in the method.

### CROSS-REFERENCE TO RELATED APPLICATIONS

Not applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

A tow bar is a device attached to a chassis of a vehicle used for towing by another vehicle. It can take the form of a ball hitch to allow swiveling and articulation, or it can take the form of a simple, heavy duty, steel bar, among other configurations. Such bars are traditionally mounted on the underside of the bumper for easy access to the chassis for mounting. The tow bar of the instant invention is mounted above the bumper and has many advantages because of this mounting.

### BRIEF SUMMARY OF THE INVENTION

Thus, what is disclosed and claimed herein is a novel tow hook and a method of providing an above bumper tow hook to a front of a pickup truck. The method comprises providing a pickup truck having a front fascia panel, a top bumper bolt, and a front chassis. Removing the fascia panel and removing any driving light to provide a first opening. Removing a top bumper bolt and guiding a tow hook into the first opening.

Attaching a reinforcing bracket having predetermined second openings to the tow hook and a portion of the front chassis of the pickup truck. Reinserting the top bumper bolt and tightening.

Adjusting a rear portion of the reinforcing bracket to predetermined second openings in the pickup truck chassis and inserting bolts through the predetermined second openings of the reinforcing bracket and the pickup truck chassis and tightening.

In another embodiment there is a finish grommet that is placed over a front end of the tow hook and adjusted into the fascia panel to provide a finished appearance.

In yet another embodiment, there is a pickup truck tow hook installation kit, wherein the kit comprises a tow hook of this invention and a reinforcing bracket, wherein the reinforcing bracket has predetermined openings therein which predetermined openings coincide with like openings in a chassis of the pickup truck.

There is a plurality of bolts for securing the tow hook and the reinforcing bracket to the chassis of the pickup truck.

A further embodiment is a finish grommet, the finish grommet being manufactured from a flexible material. The grommet has a predetermined size and a predetermined configuration.

The grommet has two ends and openings near each of the two ends and there is a slit in the flexible material running from one of the two end openings to the other end opening.

An additional embodiment is a tow bar or tow hook, that is, a vehicle mountable tow hook. The tow hook comprises a flat metal bar wherein the flat metal bar has a front end, a back end and two parallel side rails connected to the front end and the back end.

The back end has two corners and there are first lateral extensions extending from the corners. Each first lateral extension contains a through opening for a first fastener. The front end has at least one second lateral extension extending from it. The second lateral extension contains a through opening for a second fastener.

There is a through opening near a center of the vehicle mountable tow hook for containing a third fastener. The front end, parallel side rails and second lateral extension are from ½ inches to ¾ inches thick. The vehicle mountable tow hook is 8 to 12 inches long, 2 ½ inches to 4 ½ inches wide, wherein a center portion is 3/16 inches to ⅝ inches thick, the center portion having multiple open spaces.

Yet another embodiment of this invention is a metal anti-lift bracket. The anti-lift bracket comprises a rectangular flat plate, having two parallel, spaced-apart edges, each edge turned downwardly to form sides. The flat plate has a first end and a second end, the first end having a single opening through it and the second end having two, spaced-apart openings through it.

There is a metal bidirectional stressed support member in this invention, the bidirectional stressed support member comprises a top flat panel having a first end. The first end is bent downwardly at a 10 to 15° bend. The first end has a corner opening through it. There is a flat side panel integrally connected to the top flat panel by an edge. The flat side panel has a second end, the second end being bent inwardly in a 10 to 15° bend. The second end has an opening therethrough.

There is also an anti-crush spacer tube, the tube being an elongated hollow tube having two ends, one such end having a washer rigidly affixed thereto.

There are numerous accessories that can be mounted on the inventive tow hook described herein. Such accessories include, but are not limited to, a flagpole, a single tie down, a brush guard, a step-up plate, electrical light mountings, a winch mounting, a ladder/pipe support, and mountings for snowplows and the like.

As used herein, “tow bar” and “tow hook” are used interchangeably and “frame” and “chassis” are used interchangeably.

### BRIEF DESCRIPTION OF THE SEVERAL VIEWS OF THE DRAWING(S)

FIG. 1 is a full side view of a portion of a pick-up truck chassis, a tow hook, and an installation bracket at the front of a pick-up truck.

FIG. 2A is an exploded view of the tow hook installation of this invention.

FIG. 2B shows the tow hook installation in place on the chassis of a vehicle.,

FIG. 3 is a full front view of a portion of a pick-up truck with tow bars installed.

FIG. 4 is a full front view of a grommet of this invention.

FIG. 5 is a full front view of a front of a tow bar with a finish grommet in place.

FIG. 6 is a full top view of a tow hook of this invention.

FIG. 7 is a view in perspective of a tow hook on this invention with multiple lateral extensions with through openings.

FIG. 8 is a full front view of a tow hook of this invention with horizontal through openings.

FIG. 9A is a bottom view in perspective of an anti-lift bracket of this invention.

FIG. 9B is a top view in perspective of an anti-lift bracket of FIG. 9A.

FIG. 9C is a full bottom view of the anti-lift bracket of FIG. 9A.

FIG. 10 is a full top view of bidirectional stressed members installed.

FIG. 11 is a full side view of the bidirectional stressed member installed.

FIG. 12 is a flagpole accessory installed on a tow hook.

FIG. 13 is a full side view of a single post tie down accessory installed on a tow hook.

FIG. 14 is a brush guard accessory installed on two tow hooks.

FIG. 15 is a step-up plate installed on two tow hooks.

FIG. 16 is a lighting unit accessory and two tow hooks.

FIG. 17 is a full light bar accessory installed on two tow hooks.

FIG. 18 is a winch mounting mounted on two tow hooks.

FIG. 19 is a ladder/pipe support mounted on two tow hooks.

FIG. 20 is a snowplow mounting assembly mounted on a chassis of a vehicle and using two tow hooks.

### DETAILED DESCRIPTION OF THE INVENTION

Thus, what is disclosed and claimed herein is a method of providing an above bumper tow hook to a front of a pickup truck. Tow hooks are common on today's average pick-up truck because such pick-ups are customarily used for outdoor activities in woods and the like. Most such tow hooks are chassis mounted. However, they are all mounted underneath the bumper. The disadvantage is that when mired in snow or mud, one cannot access the tow hooks to attach any sort of tow cable to enable the vehicle to be towed. A second disadvantage is that if one wishes to mount accessories on a vehicle, than one has to remove the existing tow hooks from under the bumper and provide a mechanism or apparatus to mount the accessory.

The method introduced herein deals with this issue by mounting the tow hook above the bumper. This entails manipulating the front fascia which sets down directly on the bumper. This method overcomes any disadvantages in installing the tow hook under the bumper.

In addition, the inventor has discovered a method whereby the outward appearance of the finished installation does not detract from the overall finished look of the vehicle.

Most of today's pick-up trucks have the same or similar presentation on the front of the vehicle. They include a headlights, grill, front fascia panel, and the like.

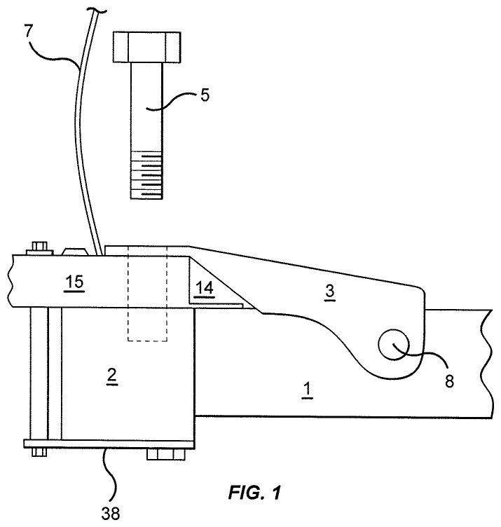

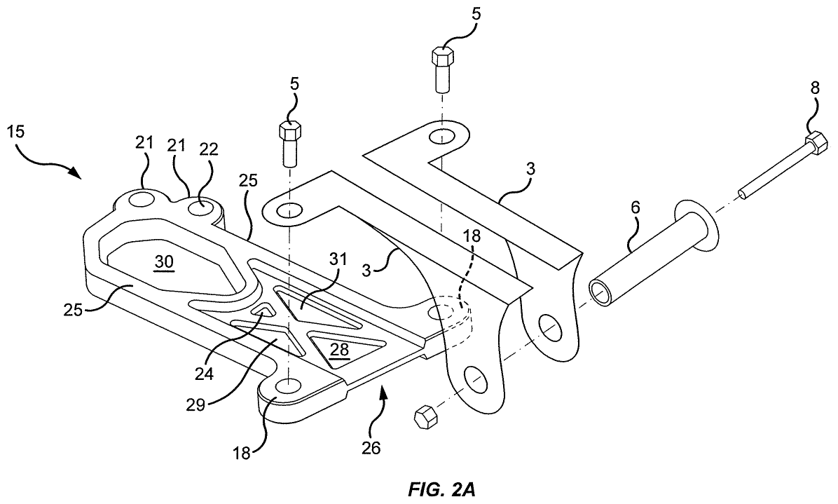

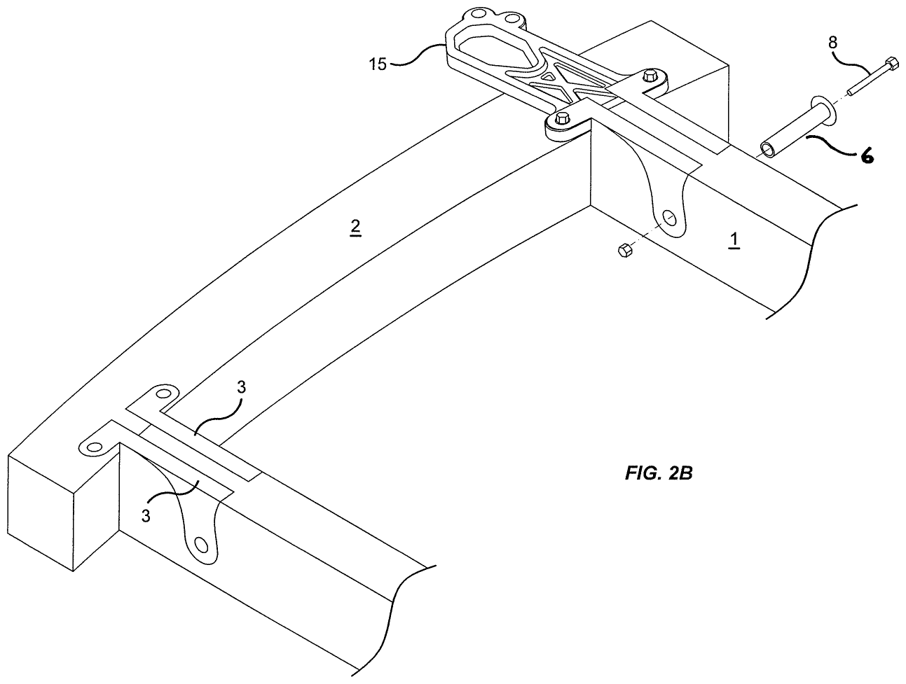

With reference to FIG. 1, there is shown a portion of a front body chassis 1 of a pick-up truck including a bumper 2, an inventive support bracket 3 (bidirectional stressed support member), a tow hook 4 of this invention, top bolt (5), bumper bolts 8, and fascia 7.

The method of this invention requires providing a pickup truck having the construction as noted just Supra, except for the tow hook and its positioning of this invention.

One removes the fascia panel 7 and any driving light 16 that interferes with the installation. The top bumper bolt 5 is removed and a tow hook 4 of this invention is inserted in the opening 14 created therein.

Thereafter, the support bracket 3 is placed over the tow bar 4 and bolted to the chassis 1 in the predetermined openings installed by the manufacturer of the vehicle using a utility bolt 8. Thereafter, the top bumper bolt 5 is reinserted into its opening in the bumper 2, after it passes through the support bracket opening, the tow hook 4 and the chassis opening. The bolt 5 is tightened. Optionally, there is an anti-lift support bracket 38 or 60 on the bottom of the bumper 2.

Not part of the inventive method herein, the driving light 16 and the fascia 7 are then reinstalled.

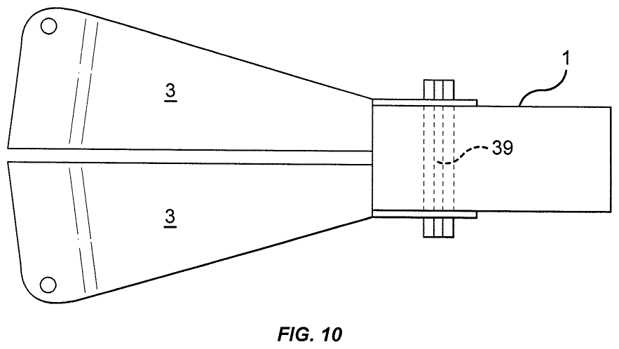

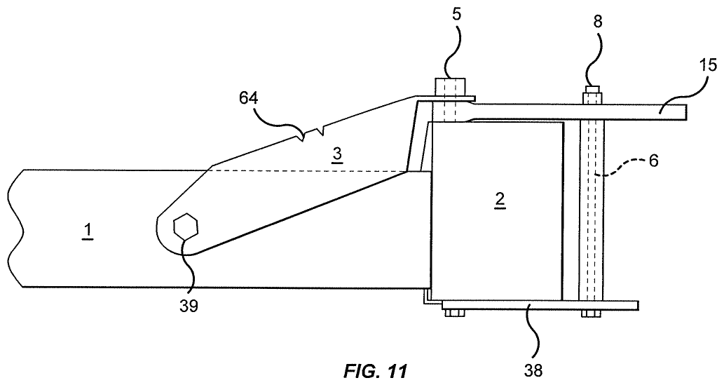

The bidirectional stressed support member 61 can be found in FIGS. 10 and 11 wherein there is shown a full top view of such a support. There is a slight, 10 to 15° downward bend in the first end 40 of the member 38 to allow alignment with the top of the bumper 2. This end 40 also has a through opening 41 that allows the member 38 to be attached to the top of the tow hook 15 using a bolt 5. There is also a slight, 10 to 15°, inwardly bend in a second end 62 of the bidirectional stressed support member 61 to allow uniform contact with the chassis 1.

Metal bidirectional stressed support member 61 can optionally have notches along one edge to permit identification of the support member.

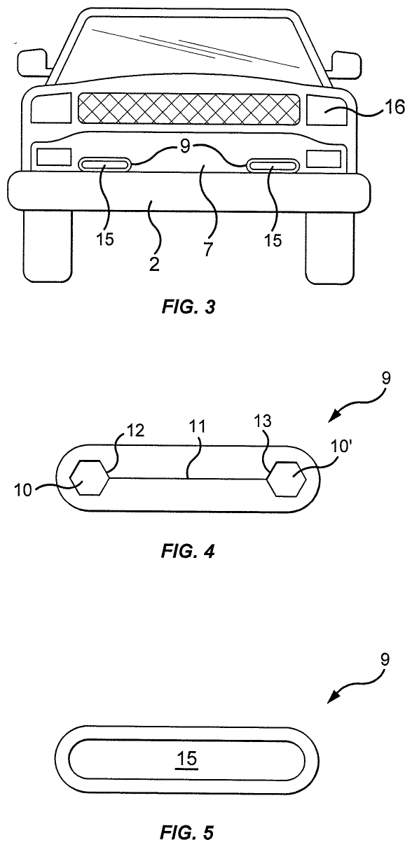

Because the installation of the tow hook 4 the front of the pick-up truck has an unfinished appearance and in order to appease this unfinished appearance, the inventor herein developed a finish covering for the tow hook installation. Such a device is found in FIG. 4, which shows the front end of the tow hook 4 and a flexible grommet 9 having the configuration shown in FIG. 3.

The grommet 9 is flexible material such as a soft plastic but is tough enough to withstand stretching over the tow hook 4. The grommet 9 has two identical openings 10 and 10′ near each end of the grommet. There is s slit 11 in the plastic that runs from the inside edge 12 of one opening 10 to the inside edge 13 of the other opening 10′. When used, the flexible material will allow the entry of the tow hook 4 through the slit 11 with the remainder of the flexible materials covering the opening 14 used for inserting the tow hook 4.

Also contemplated within the scope of this invention is a pickup truck tow hook installation kit, said kit comprises a tow hook of this invention, a bidirectional stressed support member (support bracket), and a plurality of bolts for securing the tow hook and the bidirectional stressed support member to the chassis of a pickup truck as shown in FIG. 1.

In FIG. 5, there is shown a full top view of a tow hook 15 of this invention. It should be understood that because of the location of the mounting holes in the vehicle chassis that are manufactured by the automobile manufacturer, there is a left tow hook and a right tow hook. The following description is applicable to both remembering that one tow hook is a mirror image of the other tow hook.

This above bumper mounting of tow hooks has at least two purposes, one is for mounting accessories currently available for truck mounting, and second, to provide a secure and safe means for vehicle recovery and towing.

Turning now to FIG. 5, there is shown a full top view of a tow hook 15 of this invention. The tow hook 15 is manufactured from metal such as steel, stainless steel, or iron in order to sustain forces necessary for towing. The tow hook 15 is about ½ to ¾ inches thick, 8 to 12 inches long, 2 ½ to 4 ½ inches wide at its widest point. In the event that there are two or more front openings in the tow hook 15, the overall width may be from 4 to 8 inches wide.

On the back corners 17 of the tow hook 15 are two lateral extensions 18 that have through openings 19 in them to accommodate bolts 8 for mounting the tow hook 15. The front end 20 of the tow hook 15 has at least one lateral extension 21, each such lateral extension 21 has a through opening 22 in it to accommodate bolts 8 that secure accessories that are mounted thereon (discussed infra).

Near the center 23 of the tow hook 15 is an additional through opening 24. This opening 24 is used to secure the tow hook 15 to the chassis using a bolt. Along the side rails 25, and near the back end 26, are raised platforms 27 that accommodate any open space (spacers) between the tow hook 15 and the surface to which it is mounted.

In order to reduce the weight of the tow hook 15, there are multiple open spaces such as 28, 29, 30, and 31. This can be done without sacrificing the overall strength of the tow hook 15. The size and precise configuration of such openings is not critical to the invention.

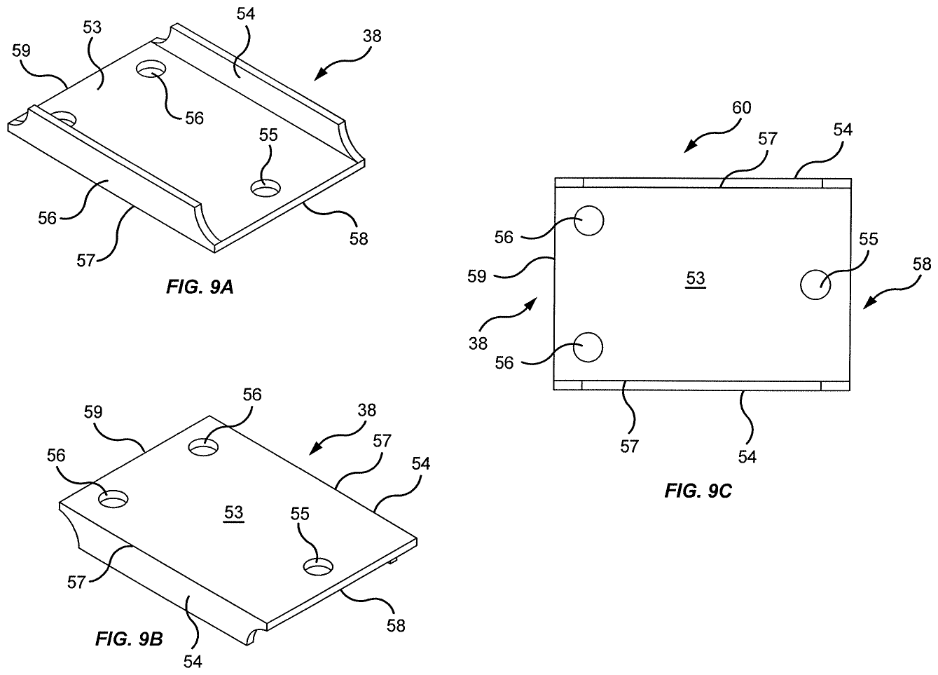

When additional support is needed for the tow hook 15, the tow hook 15 can be further supported and strengthened by the use of an anti-lift bracket 52, found in FIGS. 9A, 9B, and 9C wherein 9A is a bottom view of such an anti-lift bracket. There is shown a rectangular flat plate 53, that has two integral sides 54 along each side edge 57 of the flat plate 53. There are three predetermined locations for openings, in the first end 58 and a single opening 55, and the second end 59 with two side by side openings 56. FIG. 9B is a full top view of the anti-lift bracket of FIG. 9A and FIG. 9C is a full bottom view of a square anti-lift bracket 60.

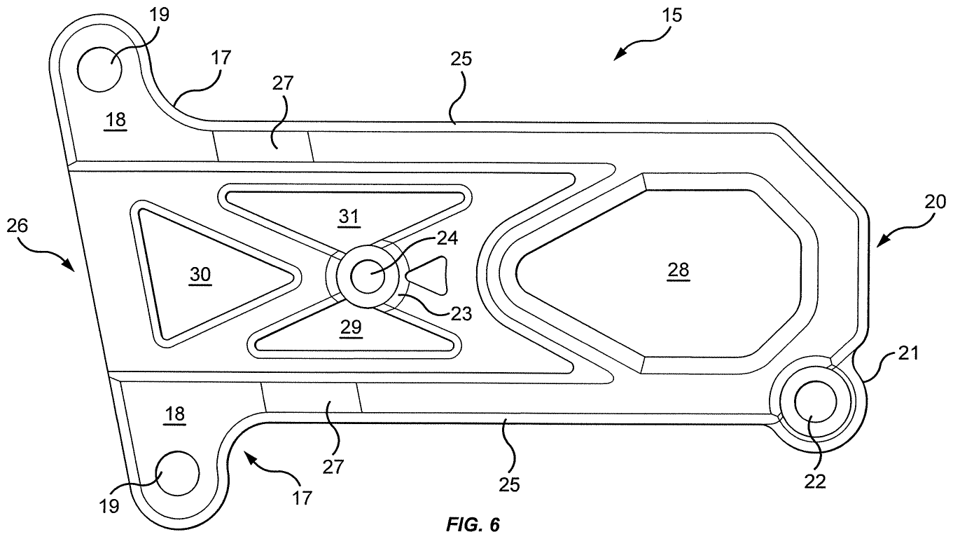

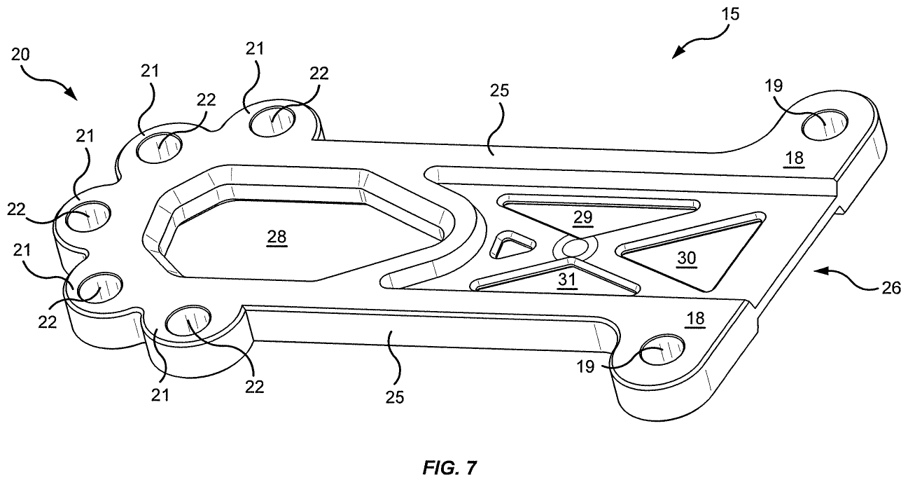

It is contemplated within the scope of this invention to provide a tow hook 15 with multiple lateral extensions 32 on the front end 20 such as shown in FIG. 6. These multiple extensions enable attachment of the various accessories to the tow hook 15 as will be discussed infra.

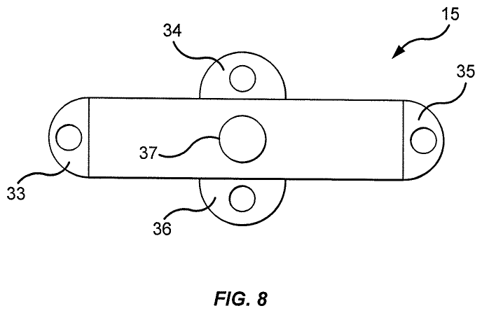

It is also contemplated within the scope of this invention to provide a tow hook 15 with horizontal openings 32 as shown in FIG. 8 wherein there is shown the tow bar 15, horizonal openings 33, 34, 35, 36, and 37.

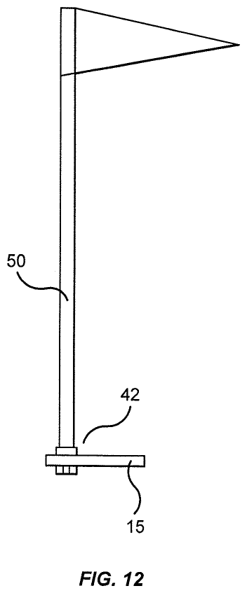

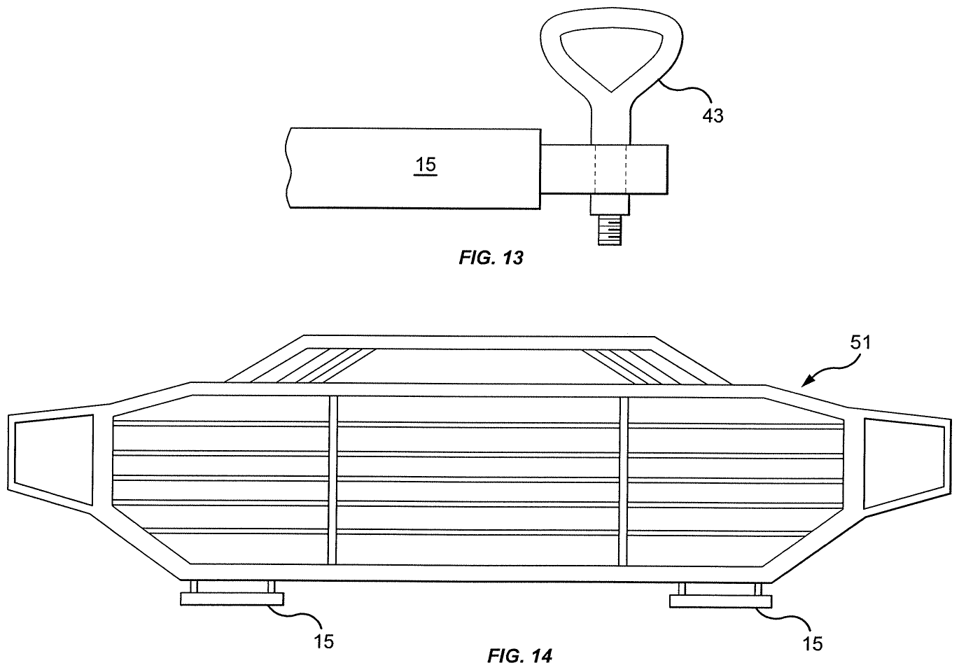

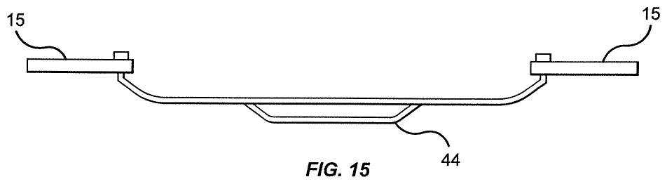

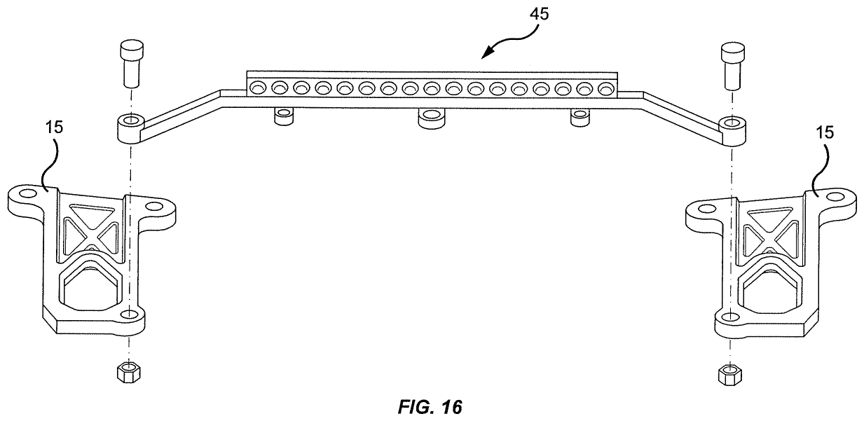

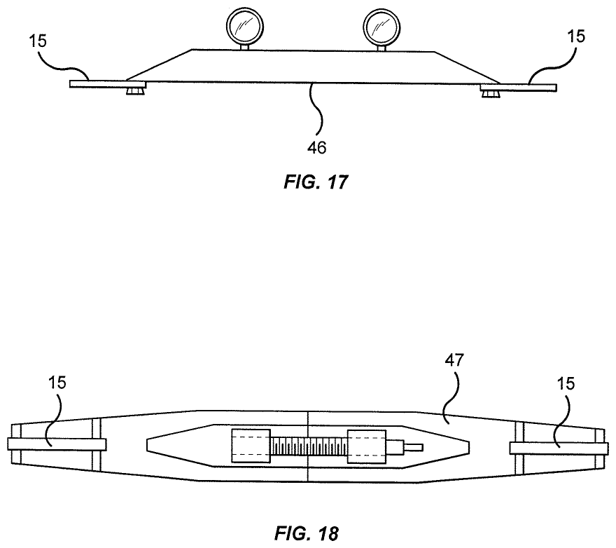

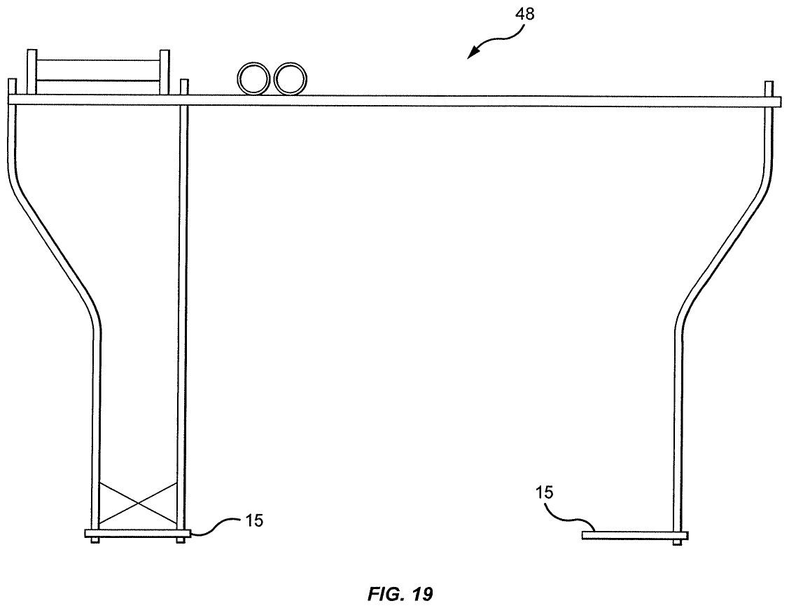

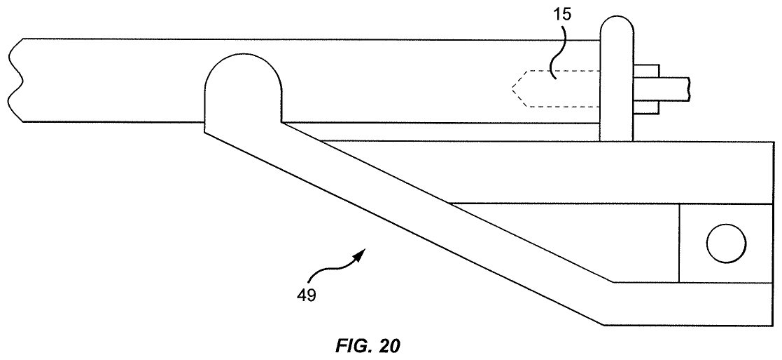

The openings 19 in the front 20 of the tow hook 15 can be used for installing accessories normally comporting with the use of a pickup truck, for example, contemplated within the scope of this invention are a flag pole 42 mount with a flag pole 50 (FIG. 12), a single tie down post 43 (FIG. 13), a brush guard 51 (FIG. 14), a step-up plate 44 (FIG. 15), a first light bar 45 (FIG. 16), a second light bar 46 (FIG. 17), a winch mount 47 (FIG. 18), a ladder/pipe support 48 (FIG. 19), and a snow plow mounting assembly 49 (FIG. 20).

What is claimed is:

1. A method of providing an above bumper tow hook to a front of a pickup truck, said method comprising:
A) providing a pickup truck having a front fascia panel, a top bumper bolt, and front chassis;
B) remove said fascia panel;
C) remove any driving light to provide a first opening;
D) remove said top bumper bolt;
E) guide a tow hook into said first opening;
F) attach a reinforcing bracket having predetermined second openings to said tow hook and a portion of said front chassis of said pickup truck;
G) reinsert said top bumper bolt and tighten;
H) adjust a rear portion of said reinforcing bracket to predetermined second openings in said pickup truck chassis;
I) insert bolts through said predetermined second openings of said reinforcing bracket and said pickup truck chassis and tighten.

2. A method as claimed in claim 1 wherein a finish grommet is placed over a front end of said tow hook and adjusted into said fascia panel to provide a finished appearance.

3. A pickup truck tow hook installation kit, said kit comprising:
A) a tow hook;
B) a bidirectional stressed support member, said bidirectional stressed support member having predetermined openings therein which predetermined openings coincide with like openings in a chassis of said pickup truck;
C) a plurality of bolts for securing said tow hook and said bidirectional stressed support member to said chassis of said pickup truck.

4. A vehicle mountable tow hook, said tow hook comprising a flat metal bar wherein there is a front end, a back end and two parallel side rails connecting the front end and the back end;
said back end having two corners and there are first lateral extensions extending therefrom, each said lateral extension containing a through opening for a fastener;
said front end having at least one second lateral extension extending therefrom, said second lateral extension containing a through opening for a fastener;
there is a through opening near a center of said vehicle mountable tow hook for containing a fastener;
said front end, parallel side rails and said second lateral extensions being ½ to ¾ inches thick, said vehicle mountable tow hook being 8 to 12 inches long and 2 ½ to 4 ½ inches wide, wherein a center portion is 3/16 to ⅝ inches thick, said center portion having multiple open spaces.

5. A vehicle mountable tow hook as claimed in claim 4 wherein said side rails, near said back end, on a top and on a bottom surface thereof, have raised platforms of ¾ to 1/½ inches long.

6. A finish grommet, said finish grommet manufactured from a flat flexible material:
said grommet having a predetermined size;
said grommet having a predetermined configuration;
said grommet having two ends and openings near each of said two ends;
a slit in said flexible material running from one of said two end openings to the other said end opening.

7. An anti-crush spacer tube, said tube being an elongated hollow tube having two ends, one such end having a washer rigidly affixed thereto.

8. A metal anti-lift support bracket, said anti-lift support bracket comprising a flat panel having two side rails and two ends, said bracket having three through openings, one in one said end and two in the opposite said end.

9. A metal bidirectional stressed support member, said bidirectional stressed support member comprising a top flat panel having a first end, said first end being bent downwardly at a 10 to 15° bend, said first end having a corner opening therethrough, a flat side panel integrally connected to said top flat panel by an edge, said flat side panel having a second end, said second end being bent inwardly in a 10 to 15° bend, said second end having an opening therethrough.

10. A metal bidirectional stressed support member as claimed in claim 9 wherein said support member is notched along one edge to permit identification of said support member.

11. The vehicle mountable tow hook as claimed in claim 4 having attached thereto a vehicle accessory.

12. The vehicle mountable tow hook in combination with a vehicle accessory as claimed in claim 11 wherein the accessory is a flagpole.

13. The vehicle mountable tow hook in combination with a vehicle accessory as claimed in claim 11 wherein the accessory is a single tie-down post.

14. The vehicle mountable tow hook in combination with a vehicle accessory as claimed in claim 11 wherein the accessory is a step-up plate.

15. The vehicle mountable tow hook in combination with a vehicle accessory as claimed in claim 11 wherein the accessory is a first light bar.

16. The vehicle mountable tow hook in combination with a vehicle accessory as claimed in claim 11 wherein the accessory is a second light bar.

17. The vehicle mountable tow hook in combination with a vehicle accessory as claimed in claim 11 wherein the accessory is a winch mounting assembly.

18. The vehicle mountable tow hook in combination with a vehicle accessory as claimed in claim 11 wherein the accessory is a ladder/pipe support.

19. The vehicle mountable tow hook in combination with a vehicle accessory as claimed in claim 11 wherein the accessory is a snowplow mounting assembly.

20. The vehicle mountable tow hook in combination with a vehicle accessory as claimed in claim 11 wherein the accessory is a brush guard.

21. The method as claimed in claim 1 wherein, in addition, there is a gasket positioned between the vehicle mounting tow hook and said top plates of said reinforcing bracket.
